(19) United States
(12) Patent Application Publication
(10) Pub. No.: US 2004/0054111 A1
(43) Pub. Date: Mar. 18, 2004

(54) Nanoscale polymerized hydrocarbon particles and methods of making and using such particles

(76) Inventors: Thomas H. Kalantar, Midland, MI (US); Q. Jason Niu, Midland, MI (US); Christopher J. Tucker, Midland, MI (US); Christopher H. Domke, Pearland, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/366,494

(22) Filed: Jul. 15, 2003

Related U.S. Application Data
(63) Continuation-in-part of application No. 10/077,642, filed on Feb. 15, 2002, now abandoned.

(51) Int. Cl. C08F 212/06

(52) U.S. Cl. 526/347

(57) ABSTRACT

This invention is cross-linked, polymerized hydrocarbon particles which composition is characterized in that the particles have an average diameter of less than 30 nm, the particles exhibit a volume swell factor of no greater than 3.0; the composition is essentially free of metal ions; the particles have a polydispersity (polystyrene relative Mw/Mn) of less than 3.0, and the particles are characterized by a Mark-Houwink plot having a slope with an absolute value of less than 0.4 for the peak molecular weight range. The invention is also a method of making nanoparticles having a weight average diameter less than 30 nm by emulsion polymerization in the substantial absence of ionic components. Finally, the invention is a method of using such particles as thermally degradable components in making porous films.

This invention was made with United States Government support under Cooperative Agreement No. 70NANB8H4013 awarded by NIST. The United States Government has certain rights in the invention.

### FIELD OF THE INVENTION

This invention relates to high purity nanoscale hydrocarbon particles, a method of making such particles using emulsion techniques, and methods of using such particles in making nanoporous films.

### BACKGROUND OF THE INVENTION

Very small crosslinked hydrocarbon based polymer particles may be made by emulsion polymerization techniques. While some teachings have been found which broadly state that any surfactant: anionic, cationic, or non-ionic may be used, specific teachings are either silent on the issue of particle size (e.g. Donescu et al., The Influence of Monomers upon Microemulsions with Short Chain Cosurfactant, J. Dispersion Sci. and Tech., vol. 22, No. 2-3, 2001, pp.231-244) or state that non-ionic surfactants alone tend to be ineffective at making very small particles and that small amounts of anionic surfactant are required to be added to obtain the desired small particle size. See e.g. The Applications of Synthetic Resin Emulsions, H. Warson, Ernest Benn Ltd., 1972, p.88, and Larpent and Tadros, Preparation of Microlatex Dispersions Using Oil-in-Water Microemulsions Colloid Polym. Sci. 269, 1171-1183 (1991). Capek, et al. teach that an ionic initiator may assist in attaining small particle sizes (about 44-80 nm) with non-ionic polyoxyethylene sorbitan monolaurate surfactant in On the Fine Emulsion Polymerization of Styrene With Non-Ionic Emulsifier, Polymer. Bull., 43, 417-424 (1999).

### SUMMARY OF THE INVENTION

Contrary to the teachings in the art, the inventors have made the surprising discovery very small particles (weight average diameters less than 30 nm) can be obtained using non-ionic surfactants and non-ionic initiators without any ionic additive.

Therefore, according to a first embodiment, this invention is a method comprising preparing a composition by combining at least one non-ionic surfactant, and at least one aqueous phase component, adding at least one monomer capable of undergoing free radical polymerization, adding a free radical initiator consisting essentially of atoms selected from carbon, hydrogen, oxygen, and nitrogen atoms, and heating to form polymerized particles having a weight average diameter of less than 30 nm, wherein at all steps of combining, adding, and heating, the composition is essentially free of ionic surfactants and is essentially free of initiators or initiator residues that comprise any atom other than carbon, hydrogen, oxygen and nitrogen; and wherein the adding steps and heating step may occur in any order. Optionally, the method further comprises one or both of the additional steps of precipitating the particles and purifying to remove metals and/or ions.

According to a second embodiment, this invention is polymerized hydrocarbon particles made by the above method.

According to another embodiment, this invention is a composition comprising cross-linked, polymerized hydrocarbon particles which composition is characterized in that the particles have a weight average diameter of less than 30 nm, the particles exhibit a volume swell factor of no greater than 3.0; the particles are essentially free of metal ions; the particles have a polydispersity (Mw/Mn) of less than 3.0, and, preferably, the particles are characterized by a Mark-Houwink plot having a slope with absolute value of that slope less than 0.4 for the peak molecular weight range.

According to yet another embodiment, this invention is the use of such cross-linked, polymerized hydrocarbon particles in the manufacture of a porous, thermoset film.

By “polymerized hydrocarbon particle” is meant a polymer particle which consists essentially of carbon, hydrogen, oxygen, and nitrogen atoms. More preferably, the polymerized hydrocarbon particle consists essentially of carbon, hydrogen and oxygen atoms.

By “essentially free of ionic surfactants” is meant that no ionic surfactant is added to the polymerization mixture and any ionic surfactant that may be present as an impurity is present in amounts less than 50 parts per million based on weight of components. More preferably, the mixture is free of ionic surfactants.

By “essentially free of initiators that comprise atoms other than carbon, hydrogen and oxygen and nitrogen” is meant that no such initiator is added to the mixture and any such initiator that may be present as an impurity is present in amounts less than 50 parts per million based on weight of components. More preferably, the mixture is free of initiators that comprise atoms other than carbon, hydrogen and oxygen.

By “volume swell factor” is meant the volume of the particle in a solvent which is a good solvent for a non-crosslinked-polymer based on the same monomer(s) divided by the volume of the particle when unswollen. A good solvent is one in which the magnitude of the polymer-solvent interactions is greater than that of the polymer-polymer interactions, and in which, therefore, the polymer chain is maximally extended. See “Textbook of Polymer Science,” F. W. Billmeyer, Jr., 3rd ed., John Wiley & Sons, New York, 1984, p. 154. For polystyrene and many other hydrocarbon particles tetrahydrofuran (THF) is the preferred solvent used. Volume swell factor may conveniently be determined from SEC/DV as further outlined in the detailed description.

By “essentially free of metal ions” is meant that the particles contain less than 5 parts per million of any one metal ion contaminant based on weight of components. More preferably the particle contains less than 2 ppm of any one metal ion. Total metal ion content is preferably less than 10 ppm, more preferably less than 5 ppm, most preferably less than 2 ppm.

By “peak molecular weight range” is meant the molecular weights defining the 25^{th} to the 75^{th} percentile for the particles.

### BRIEF DESCRIPTION OF THE DRAWINGS

FIG. 1 is a plot of molecular weight distribution and a Mark-Houwink plot (intrinsic viscosity versus molecular weight on a logarithmic scale) for a sample of representative particles of this invention.

### DETAILED DESCRIPTION OF THE INVENTION

The Method

The method of this invention has the benefit of being an efficient means to produce nanoscale polymerized hydrocarbon particles that are ionically pure as the removal of the ionic surfactants and their associated metal ions that are required by the prior art methods of making such nanoscale particles is difficult and inefficient. If the surfactant is ionic, then the residue of ionic component (e.g. a metal ion, sulfates, etc.) will be extremely difficult if not impossible to remove. Given the teachings in the art that it is difficult to achieve a very low particle size without the presence of at least some ionic species, it is surprising that this method using substantially all non-ionic surfactant species attained particle weight average diameters of less than 30 nm.

The non-ionic surfactant may be any known non-ionic surfactant that will emulsify the monomer mixture in water or other aqueous polymerization medium, and preferably will microemulsify the monomer mix and stabilize the formed nanoparticulate product in the aqueous phase. Examples of such non-ionic surfactants include polyoxyethylenated alkylphenols (alkylphenol “ethoxylates” or APE); polyoxyethylenated straight-chain alcohols (alcohol “ethoxylates” or AE); polyoxyethylenated secondary alcohols, polyoxyethylenated polyoxypropylene glycols; polyoxyethylenated mercaptans; long-chain carboxylic acid esters; glyceryl and polyglyceryl esters of natural fatty acids; propylene glycol, sorbitol, and polyoxyethylenated sorbitol esters; polyoxyethylene glycol esters and polyoxyethylenated fatty acids; alkanolamine condensates; alkanolamides; alkyl diethanolamines, 1:1 alkanolamine-fatty acid condensates; 2:1 alkanolamine-fatty acid condensates; tertiary acetylenic glycols (e.g. R1R2C(OH)C═C(OH)R1R2); polyoxyethylenated silicones; n-alkylpyrrolidones; polyoxyethylenated 1,2-alkanediols and 1,2-arylalkanediols; and alkylpolyglycosides. Alkyl polyethoxylates, polyoxyethylenated 1,2-alkanediols, and alkyl aryl polyethoxylates are preferred. Examples of commercially available non-ionic surfactants include Tergitol™ surfactants from The Dow Chemical Company, and Triton™ surfactants from The Dow Chemical Company. The amount of surfactant used must be sufficient to at least substantially stabilize the formed nanoparticulate product in water or other aqueous polymerization medium. This precise amount will vary depending upon the surfactant selected as well as the identity of the other components. The amount will also vary depending upon whether the reaction is run as a batch reaction, semi-batch reaction or as a continuous reaction. Batch reactions will generally require the highest amount of surfactant. In semi-batch and continuous reactions surfactant will become available again as the surface to volume ratio decreases as particles grow, thus, less surfactant may be required to make the same amount of particles of a given size as in a batch reaction. The Applicants have found that surfactant:monomer weight ratios of from 3:1 to 1:20, more preferably 2.5:1 to 1:15, are useful. The useful range may in fact be broader than this.

The aqueous phase component may be water or may be a combination of water with hydrophilic solvents or may be a hydrophilic solvent. The amount of aqueous phase used is preferably at least 40 percent, more preferably at least 50 percent, most preferably at least 60 percent, by weight based on the total weight of the reaction mixture. The amount of aqueous phase used is preferably no greater than 99 percent by weight, more preferably no greater than 95 percent by weight, more preferably still no greater than 90 percent by weight, and more preferably no greater than 85 percent by weight.

The initiator may be any free radical initiator consisting essentially of carbon, hydrogen, oxygen and/or nitrogen, but more preferably consists essentially of carbon, hydrogen, and oxygen. “Consists essentially of” as used herein takes is conventional meaning under U.S. patent law that no components which would materially change the properties of the compound may be present in materially effective amounts. Suitable initiators include 2,2′-azobis (2-amidinopropane) dihydrochloride, for example, and redox initiators, such as H₂O₂/ascorbic acid or tert-butyl hydroperoxide/ascorbic acid, or oil soluble initiators such as di-t-butyl peroxide, t-butyl peroxybenzoate or 2,2′-azoisobutyronitrile. The amount of initiator added is preferably 0.01-5.0, more preferably 0.02-3.0, and most preferably 0.05-2.5 parts by weight per 100 parts by weight of monomer.

The monomer is a monomer capable of undergoing free radical polymerization. The monomers are preferably compounds consisting essentially of only atoms selected from carbon, hydrogen, nitrogen and/or oxygen, more preferably selected from carbon, hydrogen, and oxygen. Suitable monomers include those containing at least one unsaturated carbon to carbon bond. A single type of monomer may be used or different monomers may be used together. Examples of monomers having one unsaturated carbon to carbon bond available for reaction include styrenes (such as styrene, alkyl substituted styrenes, aryl- alkyl substituted styrenes, alkynylaryl alkyl substituted styrenes, and the like); acrylates and methacrylates (such as alkyl acrylates or alkyl methacrylates and the like); vinyls (e.g. vinyl acetate, alkyl vinyl ether and the like); allyl compounds (e.g. allyl acrylate); alkenes (e.g. butene, hexene, heptene, etc.). Examples of compounds having more than one carbon to carbon double bond available for reaction include alkadienes (e.g. butadiene, isoprene); divinylbenzene or 1,3-diisopropenylbenzene; alkylene glycol diacrylates, etc.

According to one preferred embodiment the polymerized hydrocarbon particle is cross linked. In such a preferred embodiment at least some of the monomers will have more than one unsaturated carbon to carbon bond. Using a styrene monomer with divinylbenzene or 1,3-diisopropenylbenzene is a particularly preferred embodiment. When used, the amount of crosslinking monomer (i.e. the monomer having more than one carbon to carbon double bond available for reaction) used is preferably less than about 100, more preferably less than 70, most preferably less than 50, percent by weight based on the total weight of monomers and preferably greater than 1, more preferably greater than 5 percent by weight. The total amount of monomers added to the composition is in the range of 1 to 65, preferably 3 to 45, more preferably 5 to 35 percent by weight based on total weight of the composition.

Optionally, an additional hydrophobic solvent may be added to the monomer. Non-limiting examples of suitable solvents include toluene, ethylbenzene, mesitylene, cyclohexane, hexane, xylene, octane and the like, and combinations thereof. If used, the amount of hydrophobic solvent may be from 1 to 95%, preferably 2 to 70%, most preferably 5 to 50% by weight of the hydrophobic phase. Total amount of hydrophobic phase should be 1 to 60%, preferably 3 to 45%, more preferably 5 to 35% of the total mixture.

The processes used to make the particles according to this invention may be run as a batch process, multi-batch process, as a semi-batch process, or as a continuous process. Suitable reaction temperatures are in the range of 25 to 120° C.

1. Batch Emulsion Polymerizations:

Batch emulsion polymerizations may be carried out in several ways. For example, if an aqueous phase-soluble initiator is used, an emulsion can be formed from the monomer mixture, the aqueous phase and surfactant, heated to the desired polymerization temperature, and the water soluble initiators and redox agents, if used, added substantially all at the beginning of the polymerization. Alternately, the monomer mixture may be added all at once to an aqueous surfactant solution at the reaction temperature, followed by the initiator(s). If oil-soluble initiators are used, they are usually dissolved in the monomer phase prior to emulsification. Then, an emulsion can be formed from the monomer/initiator mixture, the aqueous phase and surfactant, and heated to the desired polymerization temperature, to effect polymerization. Alternately, the monomer/initiator mixture may be added all at once to an aqueous surfactant solution at the reaction temperature. The resulting emulsion may be held at the reaction temperature for a few minutes to several hours until the desired degree of monomer conversion is reached. Additional initiator charges may be added to complete the polymerization; the reaction may be heated after substantially complete to effect a more complete polymerization.

2. Multibatch

Another way to make the particles is to do the above polymerization, then add in a second batch of monomer, enough water to maintain the fluidity of the system, stir to emulsify, add initiator again (if water soluble initiators and optionally, redox agents are used), polymerize and repeat as many times as desired. If an oil soluble initiator is used, it may be dissolved in the monomer charge. In this manner, a higher ratio of monomer to surfactant may be attained in the polymerization than would otherwise be possible. The resulting emulsion may be held at the reaction temperature for a few minutes to several hours until the desired degree of monomer conversion is reached. Additional initiator charges may be added to complete the polymerization; the reaction may be heated after substantially complete to effect a more complete polymerization.

3. Semibatch

Another way to make these particles is to polymerize the monomers in a semi-batch mode, adding the monomers and initiators continuously to a surfactant solution at the polymerization temperature. Like batch polymerization, this mode may be practiced in many ways. For example, water soluble initiators may be added in a separate stream from the monomer stream, oil soluble initiators may be added separately, or be dissolved in the monomer stream. The monomer stream may contain one or more monomers, or each monomer may be added in a separate stream (either simultaneously, or sequentially, or simultaneously, but each one at rates that vary with time). Aqueous phase components and surfactant may also be added over the course of the polymerization. The resulting emulsion may be held at the reaction temperature for a few minutes to several hours until the desired degree of monomer conversion is reached. Additional initiator charges may be added to complete the polymerization; the reaction may be heated after substantially complete to effect a more complete polymerization.

4. Continuous

The polymerization may also be run in a continuous, or “plug-flow” manner, in which the aqueous monomer emulsion and initiators are mixed together at the desired polymerization temperature, injected into a pipe of appropriate length, and pumped down the pipe over a period of time sufficient to complete the polymerization. Reagents such as more monomers, or initiators and the like, as well as more surfactant or other aqueous phase components, as desired, may be added to the polymerizing emulsion at various points along the pipe, and different regions of the pipe may be heated or cooled to different temperatures as needed. The product latex may be removed continuously from the end of the pipe.

After making the particles, by any of the above methods, the particles may be precipitated by mixing the latex with an organic solvent or solvent mixture that is at least partially soluble in water, and in which resulting aqueous phase-solvent mixture, the formed polymer is substantially insoluble. The needed amount of said solvent should be enough to precipitate substantially all of the formed polymer from the latex. Examples of such solvents include but are not limited to acetone, methyl ethyl ketone, and methanol. This step separates out the particles which can then be used dry or be redispersed in a suitable organic solvent such as gamma butyrolactone, tetrahydrofuran, cyclohexanone, mesitylene, or dipropyleneglycol methyl ether acetate (DPMA) for subsequent use. Precipitation is also useful in removing a substantial amount of the surfactant residue.

The particles may also be purified by a variety of methods as are known in the art such as (1) passing through a bed of ion exchange resin prior to precipitation, (2) precipitating and washing thoroughly with deionized water and optionally with a solvent in which it is insoluble, or (3) precipitating, dispersing the particles in an organic solvent and passing the dispersion through a silica gel or alumina column in that solvent.

After precipitation, a drying step may be used but it is important not to heat the particles to such a temperature as could cause residual reactive groups on the particles to react and cause agglomeration and an increase in particle size.

The Composition and Particles

Another embodiment of this invention is a composition comprising cross-linked, polymerized hydrocarbon particles which composition is characterized in that the particles have a weight average diameter of less than 30 nm, the particles exhibit a volume swell factor of less than 3.0; the composition is essentially free of metal ions; the particles have a polydispersity (Mw/Mn) of less than 3.0, and the particles are characterized by a Mark-Houwink plot having an absolute value of its slope of less than 0.4 for the peak molecular weight range. While these particles may be conveniently made by the above method, it may also be feasible to make these particles by conventional methods using some ionic surfactants and/or ionic initiators. However, in such an instance the purification steps will be required and/or will be more complicated. Preferably, the particles are further characterized in that thermal decomposition in an inert atmosphere as determined by thermogravimetric analysis (from 25 to 600° C. at a temperature increase rate of 10° C./minute) reveals a residue having a weight of less than 10 percent, more preferably less than 5 percent and most preferably no greater than 1 percent of the initial weight of the sample.

The weight average diameter of the particles is less than 30 nm, more preferably less than 25 nm, and most preferably less than 20 nm. The weight average diameter of the particles is preferably greater than 1.5 nm, and more preferably greater than 1.7 nm and most preferably greater than 2.0 nm.

The average diameter may be determined by size-exclusion chromatography with universal calibration and differential viscometric detection (SEC/DV).

The SEC/DV test is performed as follows: A good solvent for the sample and for the standard, preferably polystyrene, is selected. Tetrahydrofuran is a preferred solvent. The column used for the SEC separation contains porous, crosslinked PS particles and the like, and is well suited for separating polystyrene and similar compounds according to size (hydrodynamic volume) in solution. Conventional high pressure liquid chromatography (HPLC) equipment is used for solvent delivery and sample introduction. A differential refractive index detector is used to detect the eluting sample concentration. A differential viscometer is used to detect the specific viscosity of the eluting polymer solution. These detectors are commercially available for example under the e.g. Model 2410 differential refractive index detector from Waters and model H502 differential viscometer from Viscotek, Inc. Because the concentrations injected on the SEC system are small, the ratio of specific viscosity to concentration at each SEC elution volume increment provides a reasonable estimate of the intrinsic viscosity of the polymer eluting in the particular volume increment.

The SEC/DV test enables determination of the following properties for the sample: absolute molecular weight distribution (and number average, weight average and z-average molecular weights); collapsed and swollen (i.e. in solvent) particle size distribution (and peak and weight average diameters); the Mark-Houwink plot (log[η] versus log M, where [η] is the intrinsic viscosity and M is the molecular weight); the volume swell factor (VSF) in the test solvent, and the PS-apparent molecular weight distribution (and molecular weight averages and polydispersity). The universal calibration curve is determined using narrow molecular weight distribution polystyrene (PS) and, more preferably also, narrow molecular weight distribution polyethylene oxide (PEO) standards. The curve is a plot of log([η]*M) versus elution volume. The product of [η]*M is proportional to hydrodynamic volume. Because ideal SEC sorts molecules according to hydrodynamic volume, a single universal calibration curve is obtained independent of polymer composition or architecture. Thus, with knowledge of the universal calibration curve and the intrinsic viscosity at every SEC elution volume increment, the absolute molecular weight of an unknown sample can be calculated at each elution volume increment.

Weight average diameter of the dry collapsed particle, Dw, is calculated as follows:

Absolute M and polymer concentration data at each elution volume increment allow for the calculation of absolute molecular weight averages and distributions. Transforming the absolute molecular weight axis into a particle size axis is performed according to the equation below:

Dw(in nm)=2*[(Mw)*(L⁻¹)*(density⁽⁻¹⁾)*(10²¹)*0.75*(π⁻¹)]^{1/3}

where Mw is the absolute weight average molecular weight in g/mol, L is Avogadro's number, density is the density of the dry polymer in g/cm³, 10²¹ is a factor to convert cm³ to nm³, and a spherical shape is assumed (V=4/3πr³). The factor 2 converts r (radius) to Dw (weight average diameter).

The volume swell factor (VSF) is also conveniently determined from the SEC/DV test. Specifically, the VSF is defined as the swollen volume divided by the non-swollen volume. Because the SEC/DV experiment is performed in a good solvent, the bulk intrinsic viscosity measured during the experiment is done so in the swollen state. The non-swollen intrinsic viscosity of spheres can be predicted via the Einstein equation:

$$[ η ] ( non \text{-} swollen ) = ( 1 / density ) * {lim}_{φ \to 0} \frac{( ( n / {n}_{0} ) - 1 )}{φ} = \frac{2.5}{density}$$

Where φ is the volume fraction of particles. VSF is calculated according to the equation below (multiply density into equation below to make generic):

VSF=swollen-volume/unswollen volume=[η](swollen)/[η](non-swollen)=[η](swollen)*(density of dry polymer)/2.5

Where [η](swollen) is the bulk intrinsic viscosity (volume/mass of solute) determined in the SEC/DV experiment. The density of dry PS (1 g/cm³) is used for the case of the preferred cross-linked polystyrene particles of this invention.

A second method for determination of the weight average diameter of the produced particles is by standard SEC-laser light scattering (SEC-LLS) methods. Standard SEC methods are used, and detection of the eluting sample is by a static laser light scattering detector, which measures scattering intensity at 3 angles. The absolute weight average molecular weight can be determined directly by this method, as described in the following references: (1) Polymer Chemistry, Malcolm P. Stevens, 2nd edition, Oxford University Press, 1990, pages 53-57; (2) Textbook of Polymer Science, Fred W. Billmeyer, Jr., 3rd edition, Wiley-Interscience Publishers, 1984, pages 199-204; (3) Philip Wyatt, “Absolute Characterization of Macromolecules,” Analytica Chemica Acta, 272, 1-40 (1993), and the collapsed weight average diameter, Dw, can be calculated therefrom by the equation below:

Dw(in nm)=2*[(Mw)*(L⁻¹)*(density⁽⁻¹⁾)*(10²¹)*0.75*(π⁻¹)]^{1/3}

where Mw is the absolute weight average molecular weight in g/mol, L is Avogadro's number, density is the density of the dry polymer in g/cm³, 10²¹ is a factor to convert cm³ to nm³; and the density is that of dry polystyrene, 1 g/cm³, and a spherical shape is assumed (V=4/3πr³). The factor 2 converts r (radius) to Dw (weight average diameter).

A third method of determining z-average particle diameter is by standard methods of dynamic light scattering in a good solvent, such as tetrahydrofuran (THF), as discussed in the references listed above. From the swollen z-average diameter, Dz_{good solvent}, determined by this method, the collapsed z-average diameter, Dz, can be calculated from the following equation:

Dz(in nm)=Dz_{good solvent}*[VSF_{good solvent}]^{-1/3}

where the VSF_{good solvent} is that determined by differential viscometry, in the good solvent, as described above.

The z-average collapsed particle diameter can be converted to a weight average collapsed particle diameter, Dw, by the following equation:

Dw(in nm)=Dz(in nm)*[Mw/Mz]^{1/3},

Where Mw and Mz are the absolute weight and z-average molecular weights determined from the SEC DV method described above.

The composition is essentially free of metal ions. Metal contents were determined by standard inductively-coupled plasma-mass spectrometry (ICP-MS) or neutron activation analysis (NAA) methods.

The particles have a polydispersity (Mw/Mn) of less than 3.0, preferably less than 2.5, more preferably less than 2.0. The polydispersity is obtained from the molecular weight distribution relative to linear polystyrene standards having absolute peak molecular weights of from 4,000,000 to 578. The polydispersity provides an approximation of the variation in particle size for the composition.

Finally, the particles are characterized by a Mark-Houwink plot having a slope of absolute value less than 0.4, preferably less than 0.3, more preferably less than 0.2, for the peak molecular weight range. The slope on a Mark-Houwink plot gives an indication of particle shape, with slopes of 0.7 being characteristic of substantially linear polymers and slopes of 0 being characteristic of a three dimensional Newtonian object (e.g. a sphere). The slope of the Mark-Houwink plot to be examined is from M (absolute molecular weight) corresponding to the 25^{th} weight percentile to that corresponding to the 75^{th} weight percentile.

The particles are likely to retain residual reactive vinyl groups in the interior of the particle and on the surface. In addition, the particles may contain functional groups other than residual olefin in the interior and/or on the surface. For example, the particles may contain hydroxyl, carboxylates, halogens, amines, amides, esters, or acetylene functional groups. These functional groups may be present as residual components of such monomers as α-chloromethyl styrene, chlorostyrene, 2-hydroxyethyl acrylate or methacrylate, hydroxypropyl acrylate or methacrylate, 4-hydroxybutyl acrylate or methacrylate, phenylethynyl styrene, vinylbenzoic acid, acrylic acid, methacrylic acid, acrylamide, N-vinyl formamide, divinylbenzene, 1,3-diisopropenyl benzene, etc., or may be added by reaction of the residual vinyl group with a functionalizing compound such as reaction of vinyl groups in the particle with hydrogen over a catalyst, or reaction with a reagent with at least one hydrogen-boron bond, followed by oxidation of the resulting boron-carbon bond to form an alcohol functional group.

Use of Particles as Porogens

The inventors have found the particles of this invention to be particularly useful as porogens in making cross-linked porous films. In this use, the particles are combined or mixed with precursors to a cross-linked matrix material. Examples of such matrix materials include benzocyclobutene based resins, such as Cyclotene™ resins from The Dow Chemical Company, polyarylene resins and polyarylene ether resins, such as SiLK™ polyarylene resins from The Dow Chemical Company, silsesquioxanes, etc. Preferably, the porogens are grafted to the matrix precursor. This may be accomplished by adding the porogens to the monomers prior to B-staging (partial polymerization) as residual ethylenically unsaturated groups on the porogen are available to react with reactive groups on the monomers. Alternatively, some B-staging may occur prior to addition of the porogen and the porogen may be grafted by subjecting the mixture to conditions sufficient to cause residual ethylenically unsaturated groups on the porogen to react with residual react groups in the B-staged reaction product. The mixture is then coated onto a substrate (preferably solvent coated as for example by spin coating by known methods). The matrix is cured and the porogen is removed by heating it past its thermal decomposition temperature. Porous films such as these are useful in making integrated circuit articles where the films separate and electrically insulate conductive metal lines from each other.

### EXAMPLES

Reagents: Styrene (S, 99%, Aldrich), divinylbenzene (DVB, tech., 80%, Aldrich), 1,3-diisopropenylbenzene (DIB, 96%, Aldrich), 4-hydroxybutyl acrylate (Aldrich), H₂O₂ (30% aqueous, Fisher), tert-butyl hydroperoxide (TBHP, 70%, Aldrich); ascorbic acid (Aldrich), 1-pentanol (Fisher), Aerosol-OT™ ionic surfactant (AOT, 10% aqueous, Sigma), sodium dodecyl sulfate (SDS, 98%, Aldrich), 9-borabicyclo[3,3,1]nonane (9-BBN, 0.5 M in tetrahydrofuran, Aldrich) Tergitol NP™ series nonylphenol ethoxylates (The Dow Chemical Company) and Tergitol 15-s™ (The Dow Chemical Company) series secondary alcohol ethoxylates were used as received. All polymerizations were conducted in ultra-pure deionized water (UPDI-H₂O, passed through a Barnstead purifier, conductivity <10⁻¹⁷Ω⁻¹) under nitrogen. Fisher Scientific HPLC grade solvents were used throughout, as received.

Batch polymerizations: Emulsions were prepared by mixing the monomer mix, surfactant mix and water with gentle stirring. The emulsion was introduced into a temperature-controlled, N₂-purged reactor of appropriate size (glass or stainless steel), with overhead stirring (700-1000 rpm). The emulsion was stirred and purged with nitrogen for at least 20 minutes. 30% H₂O₂ or 70% TBHP and the appropriate ascorbic acid solution (usually 2 wt % aqueous) were introduced rapidly at the set temperature (30° C. unless otherwise noted). Polymerization was allowed to continue for 1 hour unless otherwise noted in Table A. An exotherm of 5-17° C. was typically observed 3-15 minutes after initiation.

Particle Isolation: Method 1: To a given volume of latex, an equal volume of methyl ethyl ketone (MEK) was added. The resulting suspension was centrifuged at 2000 rpm for 20 minutes (IEC Centra GP8R; 1500 G-force). The liquids were decanted and the solid was resuspended in 1× original volume of 1:1 UPDI H₂O:Acetone, centrifuged, decanted (repeat two times) and the solids were dried for ˜70 hours in a stream of dry air.

Particle Isolation: Method 2: To a given volume of latex, an equal volume of MEK was added. The resulting suspension was centrifuged as above. The liquids were decanted and the solid was then blended in UPDI H₂O, then added to acetone (equal volume). It was then filtered, washed with several volumes of methanol or 1:1 UPDI H₂O:acetone, then UPDI H₂O, then methanol. The solids were dried for ˜70 hours in a stream of dry air.

Particle Isolation: Method 3: To a given volume of latex, an equal volume of MEK was added. The resulting suspension was centrifuged as above. The liquids were decanted and the solid was dissolved in a minimum amount of THF solvent, then precipitated by adding the THF solution slowly to a 5 to 10-fold excess of methanol, filtering, washing the filter cake with methanol, and drying as above.

### Example 1

This example shows representative batch polymerizations within the method of this invention. A batch polymerization run was conducted according to the general batch polymerization procedure above, and the initial emulsion was prepared according to the formulations in Table A, and had size and particle characteristics as reported in Table A. The particles were isolated by Method 2.

TABLE A

| | | | | | | | | INITIATORS | | | | | |
|---|---|---|---|---|---|---|---|---|---|---|---|---|---|
| | MONOMER MIX | | | | | | | | | 2% | | | |
| | | | Other | SURFACTANT MIX | | | | 70% | 30% | Ascorbic | | | PS- |
| | Styrene, | DVB-80, | Monomer or | Tergitol | Tergitol | Other | UP DI | TBHP | H2O2 | Acid | SEC* | SEC | Relative |
| Example # | g | g | Solvent, g | NP-15, g | NP-4, g | Surfactant, g | H₂O, g | ml | ml | ml | Dv, nm | VSF | PDI** |
| 1 | 32.34 | | 6.16 g DIB | 52.5 | | | 160 | | 2.9 | 4.8 | 10.5 | 2.79 | 1.14 |
| 2 | 34.65 | 3.85 | | 52.5 | | | 160 | 3.9 | | 4.8 | 13.3 | 4.76 | nd |
| 2 | 36 | 4 | | | | | +75 | 3 | | 5 | 13.8 | 4.2 | nd |
| 2 | 36 | 4 | | | | | +50 | 3 | | 5 | 13.8 | 3.9 | nd |
| 2 | 36 | 4 | | | | | +50 | 3 | | 5 | 16.7 | 3.37 | 1.48 |
| Comp Ex | 45 | 6.25 | | 39.75 | 3.228 | 1.70 g 10% | 189.5 | | 1.88 | 3.12 | 7.1 | 3.8 | nd |
| 1+ | | | | | | AOT | | | | | | | |
| 3 | 20.88 | 2.32 | 1.2 g | 48.7 | 3.2 | | 183.5 | | 1.88 | 3.12 | nd | nd | nd |
| | | | Toluene | | | | | | | | | | |
| 4 | 15.6 | 0.83 | 0.177 g 4- | | | 45.1 g SDS | 423 | | 1.23 | 2.05 | 14.4 | 3 | 1.2 |
| | | | hydroxybutyl | | | | | | | | | | |
| | | | acrylate, | | | | | | | | | | |
| | | | 16.1 g | | | | | | | | | | |
| | | | 1-pentanol | | | | | | | | | | |

+This was run for 90 minutes.
*The SEC DV results were obtained using a column calibrated to polystyrene only. Applicants have learned that such a column yields weight average diameters for particles made with non-ionic surfactants that are somewhat lower than the values obtained by other methods of determining average diameter. Results more consistent with other methods are obtained using a column calibrated to both polystyrene and polyethylene oxide.
**The SEC DV results were obtained using a column calibrated to polystyrene only. Applicants have learned that such a column yields polydispersities for particles made with non-ionic surfactants that are somewhat lower than the values obtained by other methods of determining polydispersity. More reliable results are obtained using a column calibrated to both polystyrene and polyethylene oxide.

TABLE A

| | | | | | | | | INITIATORS | | | | | |
|---|---|---|---|---|---|---|---|---|---|---|---|---|---|
| | MONOMER MIX | | | | | | | | | 2% | | | |
| | | | Other | SURFACTANT MIX | | | | 70% | 30% | Ascorbic | | | PS- |
| | Styrene, | DVB-80, | Monomer or | Tergitol | Tergitol | Other | UP DI | TBHP | H2O2 | Acid | SEC* | SEC | Relative |
| Example # | g | g | Solvent, g | NP-15, g | NP-4, g | Surfactant, g | H₂O, g | ml | ml | ml | Dv, nm | VSF | PDI** |
| 1 | 32.34 | | 6.16 g DIB | 52.5 | | | 160 | | 2.9 | 4.8 | 10.5 | 2.79 | 1.14 |
| 2 | 34.65 | 3.85 | | 52.5 | | | 160 | 3.9 | | 4.8 | 13.3 | 4.76 | nd |
| 2 | 36 | 4 | | | | | +75 | 3 | | 5 | 13.8 | 4.2 | nd |
| 2 | 36 | 4 | | | | | +50 | 3 | | 5 | 13.8 | 3.9 | nd |
| 2 | 36 | 4 | | | | | +50 | 3 | | 5 | 16.7 | 3.37 | 1.48 |
| Comp Ex | 45 | 6.25 | | 39.75 | 3.228 | 1.70 g 10% | 189.5 | | 1.88 | 3.12 | 7.1 | 3.8 | nd |
| 1+ | | | | | | AOT | | | | | | | |
| 3 | 20.88 | 2.32 | 1.2 g | 48.7 | 3.2 | | 183.5 | | 1.88 | 3.12 | nd | nd | nd |
| | | | Toluene | | | | | | | | | | |
| 4 | 15.6 | 0.83 | 0.177 g 4- | | | 45.1 g SDS | 423 | | 1.23 | 2.05 | 14.4 | 3 | 1.2 |
| | | | hydroxybutyl | | | | | | | | | | |
| | | | acrylate, | | | | | | | | | | |
| | | | 16.1 g | | | | | | | | | | |
| | | | 1-pentanol | | | | | | | | | | |

+This was run for 90 minutes.
*The SEC DV results were obtained using a column calibrated to polystyrene only. Applicants have learned that such a column yields weight average diameters for particles made with non-ionic surfactants that are somewhat lower than the values obtained by other methods of determining average diameter. Results more consistent with other methods are obtained using a column calibrated to both polystyrene and polyethylene oxide.
**The SEC DV results were obtained using a column calibrated to polystyrene only. Applicants have learned that such a column yields polydispersities for particles made with non-ionic surfactants that are somewhat lower than the values obtained by other methods of determining polydispersity. More reliable results are obtained using a column calibrated to both polystyrene and polyethylene oxide.

### Example 2

This example shows a multibatch polymerization within the method of this invention. An emulsion formulation containing 52.5 g Tergitol™ NP-15, 160 g UPDI H₂O, and 38.5 g of a 90/10 (w/w) styrene/divinylbenzene monomer mix was polymerized as described in the general procedure, at 30° C., using 3.9 ml TBHP and 4.8 ml 2% ascorbic acid for 1 hour (1^{st} sample). Then an additional 75 ml UPDI H₂O and 40.0 g monomer mix were added, and the reaction was stirred for 1 hour, and then initiated with 3.0 ml TBHP and 5.0 ml 2% ascorbic acid at 30° C., and the reaction was stirred for 1 hour (2^{nd} sample). Then an additional 50 ml UPDI H₂O nd 40.0 g monomer mix were added, and then initiated with 3.0 ml TBHP and 5.0 ml 2% ascorbic acid at 30° C., and the reaction was stirred for 1 hour (3^{rd} sample). Then an additional 50 ml UPDI H₂O nd 40.0 g monomer mix were added, and then initiated with 3.0 ml TBHP and 5.0 ml 2% ascorbic acid at 30° C., and the reaction was stirred for 1 hour (4^{th} sample). The particles were isolated by method 2.

### Comparative Example 1

The polymerization was carried out according to the general batch procedure using the reactants shown in Table A, and the particles isolated by Method 3. Na⁺ was determined to be 27+/−1 ppm by NAA.

### Example 3

Ion Exchange for Metal Removal:

This example shows a method of purification via cation exchange for particles made by the method of this invention. The polymerization was carried out according to the general batch procedure, and the particles were not isolated. The resulting latex was divided into two aliquots, a blank untreated one and one treated by passage through a 7″×¾″ diameter column of washed (UPDI H₂O) Dowex 50-W XT strong acid (H⁺ form) cation exchange resin. Results are shown in the table below:

| | Ppm | Ppm |
|---|---|---|
| Sample | Sodium | Potassium |
| untreated | 2.3 ± 0.1 | 140 ± 7 |
| treated. | N.D. @ 0.1 | N.D. @ 0.5 |

N.D. = not detectable at the detection limit specified.

### Example 4

This example shows that while it is possible to purify particles made with ionic surfactants the metal levels remain higher than in particles made by the method of this invention. Such purified particles may nevertheless meet the limitations of the composition of this invention.

In a flask were mixed, with stirring, at room temperature, the following: styrene (15.6 g), divinylbenzene (80%; 0.83 g), sodium dodecyl sulfate (45.1 g), 1-pentanol (16.1 g), 4-hydroxybutyl acrylate (0.177 g) and UPDI water (423 g). The mixture was stirred until clear to the eye. The mixture was purged with nitrogen gas for 20 minutes, and heated under nitrogen to 30° C. Hydrogen peroxide (30% aqueous; 1.23 mL) and a 2% aqueous solution of ascorbic acid (2.05 mL) were added. The polymerization continued for 60 minutes. The solid was isolated by Method 1. SEC DV analysis indicated that the particle diameter was 14.4 nm, and the volume swell factor was 3.0. Purification: 1.5 g of the resulting polymer was dissolved in 15 mL CH₂Cl₂, and chromatographed on silica gel (70-230 mesh,) eluting with CH₂Cl₂. 1.39 g were recovered after evaporation of the solvent. The metal content was determined by ICP/MS and reported in Table B.

### Example 5

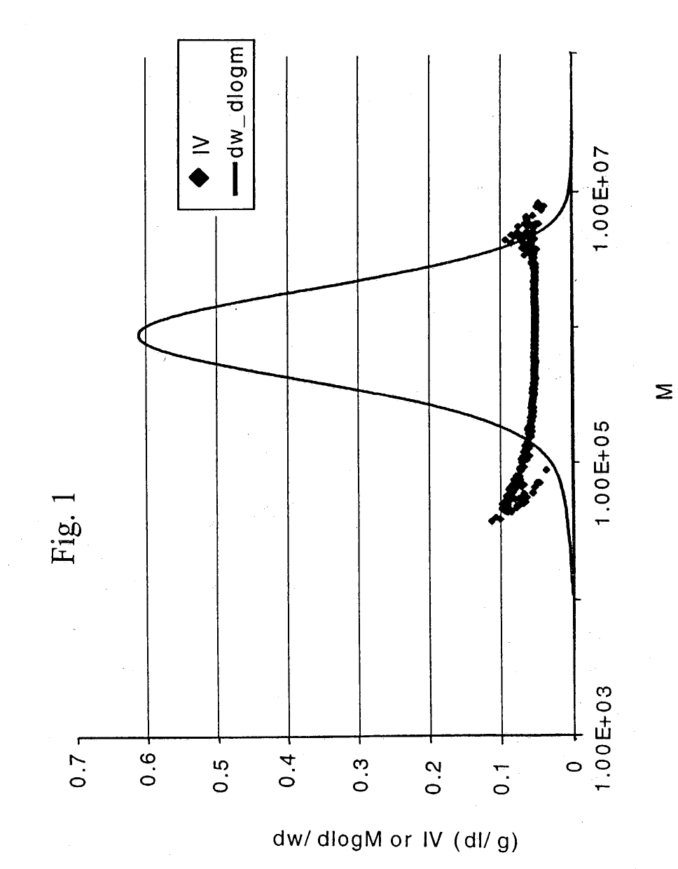

Semi-batch Polymerization: Tergitol™ 15-s-15 surfactant (52.8 g) and water (211.2 g) were added to a nitrogen-blanketed reactor, stirred and purged with nitrogen gas for 30 minutes., and heated to the set temperature (30° C.). A monomer mixture composed of styrene (45.0 g), and divinylbenzene-80 (3.0 g), 1,3-diisopropenylbenzene (9.0 g), and 4-tert-butylstyrene (3.0 g), and two initiator streams, one of 30 wt % hydrogen peroxide (9.0 g) and one of 2.0 wt % aqueous ascorbic acid (3.0 g) were continuously added over 90 minutes. The addition rates were 43.9 ml/hr for the monomer mix, and 6.0 ml/hr for the H₂O₂, and 2.0 ml/hr for the ascorbic acid solution. The reaction was allowed to proceed for 5 minutes following the completion of the additions. The weight average diameter by the SEC DV method was 15.4 nm, the volume swell factor was 2.10 (The SEC DV results were obtained using a column calibrated to polystyrene and polyoxyethylene), and the PS-relative polydispersity was 1.30. The collapsed z-average diameter determined by dynamic light scattering was 17.5 nm. The collapsed weight average diameter calculated from the absolute weight average molecular weight determined by the SEC-LLS method was 16.6 nm. The particles were isolated by Method 2. The metal levels are reported in Table B. The residue after thermal treatment under nitrogen at 500° C. was 0.37 wt % as determined by TGA analysis. The Mark-Houwink plot and molecular weight distribution plot are shown in FIG. 1.

In FIG. 1, the y-axis for the molecular weight distribution plot is the differential weight fraction with respect to log M (dw/dlogM) while the x-axis is molecular weight (M) plotted on a logarithmic scale. For the Mark-Houwink plot, the y-axis is intrinsic viscosity in deciliters/gram plotted on a logarithmic scale versus M also plotted on a logarithmic scale. The intrinsic viscosity values (denoted IV) are represented by the squares while the dw/dlogM values are represented by the smooth black line.

TABLE B
Metals content in parts per billion

| | | Comp Ex | | | |
|---|---|---|---|---|---|
| Example | 2 | 1 | 3 | 4 | 5 |
| Element | | | | | |
| Aluminum | 110 | | | 320 | 300 |
| Magnesium | * | | | 240 | * |
| Calcium | 510 | | | 1350 | 430 |
| Copper | * | | | 660 | 110 |
| Iron | 170 | | | 340 | 280 |
| Potassium | * | | ND @ 500 | 480 | * |
| | | | ppb¹ | | |
| Sodium | 290 | 27000¹ | ND @ 100 | 100 | 220 |
| | | | ppb¹ | | |
| Zinc | * | | | 870 | * |
| Chromium | * | | | * | * |
| Zirconium | * | | | * | * |
| Total | 1080 | nd | nd | 4360 | 1340 |

*= Not detected at or greater than level of quantitation (LOQ), usually 100 ppb.
Other elements not detected at greater than this LOQ are: Ba, Be, Bi, Cd, Cs, Co, Ga, In, Pb, Li, Mn, Mo, Ni, Rb, Ag, Sr, Th, Sn, Ti, and V.
¹NAA analysis, Na &/or K only.

### Example 6

This example shows making of a porous film using the particles of Example 5 as porogens. Into a round bottom flask equipped with a side arm gas inlet valve were added 3.00 grams of monomer of the formula

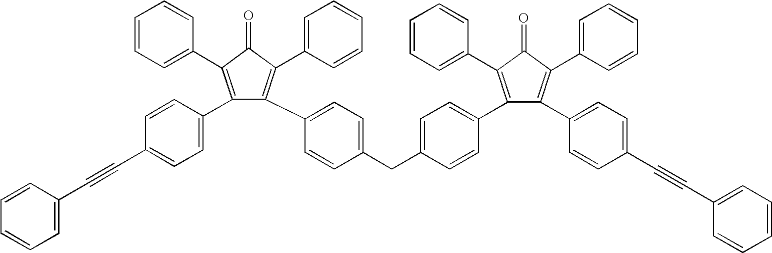

1.28 grams of the particle described in Example 5, above, 8.0 mL of gamma butyrolactone solvent, and a teflon stirring bar. After sealing the reaction flask with a silicon rubber septum cap, the mixture was degassed by repeated evacuation and purging with dry, oxygen-free nitrogen gas. It was then placed in an oil bath at ca. 150° C. with stirring and the temperature of the bath was then raised to, and maintained at, 200-205° C. for a period of five hours. Upon completion of the reaction, the reaction mixture was cooled by removing it from the heated oil bath and 12.6 mL of cyclohexanone was added to dilute the reaction product to 15 wt % total solids. This final mixture was filtered using a 0.45 um nylon filter membrane and a portion of the mixture was spun onto a silicon wafer in a clean room environment. The wafer was placed on a hot plate under a nitrogen atmosphere at 150° C. for 2 minutes to remove the solvents, and then cooled to room temperature. The coated wafer was then placed in a furnace and heated to 430° C. at a heating rate of 7° C./minute in a nitrogen atmosphere and held at that temperature for 40 minutes. Upon cooling to room temperature, the resulting crosslinked porous dielectric film was characterized by measuring its refractive index, light scattering properties, and obtaining transmission electron micrographs (TEM) to aid in determining the pore size. A value of 1.4691 was obtained for the refractive index, compared to 1.6335 for the non-porous polymer film. This indicates that the film was indeed porous Examination of the sample film using TEM revealed a pore size range of approximately 7-32 nm, with an average pore size of ca. 13 nm.

### Example 7

Hydroboration of Cross-Linked Polystyrene Nanoparticles.

This example shows one method of obtaining nanoparticles having alternative functional groups, in this case hydroxyl groups. One gram of particles similar to those of Example 1 was mixed with 10 ml of THF and a solution of 9-borabicyclononane (9-BBN) in THF (0.5M, 7 ml). The reaction mixture was heated to reflux and stirred at that temperature for 1 hour. After cooling to 30° C., NaOH (3M, 5 ml) was added. Finally, the mixture was quenched with 1.5 ml of 30% hydrogen peroxide and extracted with methylene chloride. After evaporating the solvent, the cross-linked polystyrene particle mixture was precipitated into methanol to give the hydroxyl functionalized cross-linked polystyrene particle. Hydroxyl determination was by titration with toluenesulfonyl isocyanate in tetrahydrofuran, as is known in the art, gives 28 OH groups per cross-linked polystyrene molecule and IR spectroscopy shows an OH stretch band at 3590 cm⁻¹. Using the same method, a cross-linked polystyrene nanoparticle made with divinylbenzene as the cross-linker rather than 1,3-diisopropenyl benzene was converted to hydroxy functionalized particle. The relative vinyl content was decreased from 0.136 to 0.074 in this case based on Raman spectroscopic method disclosed in Sundell, et al. Polym. Prepr. (Am. Chem. Soc. Div. Polym. Chem.) 1993, 34, 546.

### Example 8

Eight (8) grams of methylacrylate, 8 grams of methyl methacrylate and 4 grams of allyl methacrylate were treated separated with activated basic aluminum oxide (50-200 micron) to remove inhibitors and were then combined. Tergitol NP30 (ethoxylated nonylphenol surfactant) (61.29 g of 70% active) and 6.87 grams Igepal CO-660 ethoxylated nonylphenol surfactant from Rhodia Inc. were dissolved in 200 ml deionized water and introduced to a stirred jacketed reactor. The reactor was then purged with nitrogen for 30 minutes with the stirrer going at 200 rpm. A 10 ml solution of 10% hydrogen peroxide and a 10 ml solution of 1% ascrobic acid were introduced consecutively into the reactor. The following mixtures were injected into the reactor via syringe pumps: 16.9 ml of the monomer mixture at a rate of 4 ml/hour; 10 ml of a 10% hydrogent peroxide solutioin at 2.0 ml/hour and 10 ml of a 1% ascorbic acid solution at 2.0 ml/hour. The reactor was stirred at 200 rpm and purged with nitrogen at 20 ml/min and the temperature was held constant at 24° C. Photon correlation spectroscopy was used to determine the number and volume average particle size of the resulting product. Number average particle size was 16.1 nm while volume average particle size was 21.6 nm.

An equal volume of methanol was added to the above composition and the resulting precipitate was centrifuged at 2000 rpm and 5° C. for 30 minutes. The supernatant was decanted and the solid was re-suspended in 100 ml of acetone. The suspension was precipiated by addition of 200 ml deionized water, centrifuged and the supernatant decanted. The solids were dried overnight.

A porous film can be made with the particles of this Example according to the procedure set forth in Example 6.

What is claimed is:

1. A method of preparing a composition comprising combining at least one non-ionic surfactant, and at least one aqueous phase component, adding at least one monomer capable of undergoing free radical polymerization, adding a free radical initiator consisting essentially of atoms selected from carbon, hydrogen, nitrogen and oxygen atoms, and heating to form polymerized particles having a weight average diameter of less than 30 nm, wherein at all steps of combining, adding, and heating, the composition is essentially free of ionic surfactants and is essentially free of initiators that comprise any atom other than carbon, hydrogen, nitrogen and oxygen, and wherein the adding steps and heating step may occur in any order.

2. The method of claim 1 further comprising precipitating the polymerized particles.

3. The method of claim 1 further comprising purifying the composition after polymerization to remove ionic species.

4. The method of claim 1 wherein the free radical initiator consists essentially of atoms selected from carbon, hydrogen, and oxygen.

5. The method of claim 1 wherein the composition is essentially free of initiators that comprise any atom other than carbon, hydrogen, and oxygen.

6. The method of claim 1 wherein the monomer consists essentially of atoms selected from carbon, hydrogen, oxygen, and nitrogen.

7. The method of claim 6 wherein the monomer consists of atoms selected from carbon, hydrogen, and oxygen.

8. The method of claim 6 wherein the monomer is a compound having one ethylenically unsaturated carbon to carbon bond capable of undergoing free radical polymerization and a second monomer having two ethylenically unsaturated carbon-to-carbon double bonds capable of undergoing free radical polymerization is also added.

9. The method of claim 8 wherein the monomer is a styrenic monomer and the second monomer is divinylbenzene or 1,3-diisopropenylbenzene.

10. The method of claim 1 wherein the weight average diameter is less than 25 nm.

11. The method of claim 1 wherein the weight average diameter is less than 20 nm.

12. The method of claim 1 wherein the aqueous phase component, the non-ionic surfactant, and the monomer are combined to form a emulsion, the emulsion is heated to a temperature in the range of 25 to 90° C., and the initiator is added to the heated emulsion.

13. The method of claim 8 wherein after initial reaction a second batch of monomer and sufficient aqueous component to maintain fluidity in the system is added, the composition is stirred to form a second emulsion, and additional initiator is added to form additional particles.

14. The method of claim 1 wherein the aqueous phase component, and the non-ionic surfactant are combined and heated to a temperature in the range of 25 to 90° C., and the monomer and initiator are continuously added.

15. The method of claim 1 wherein the non-ionic surfactant is selected from polyoxyethylenated alkylphenols; polyoxyethylenated straight-chain alcohols; polyoxyethylenated secondary alcohols, polyoxyethylenated polyoxypropylene glycols; polyoxyethylenated mercaptans; long-chain carboxylic acid esters; glyceryl and polyglyceryl esters of natural fatty acids; propylene glycol, sorbitol, and polyoxyethylenated sorbitol esters; polyoxyethylene glycol esters and polyoxyethylenated fatty acids; alkanolamine condensates; alkanolamides; alkyl diethanolamines, 1:1 alkanolamine-fatty acid condensates; 2:1 alkanolamine-fatty acid condensates; tertiary acetylenic glycols; polyoxyethylenated silicones; n-alkylpyrrolidones; polyoxyethylenated 1,2-alkanediols and 1,2-arylalkanediols; and alkylpolyglycosides.

16. The method of claim 1 wherein the non-ionic surfactant is selected from alkyl polyethoxylates, polyoxyethylenated 1,2-alkanediols and 1,2-arylalkanediols, secondary alcohol polyethoxylates, and alkyl aryl polyethoxylates.

17. The method of claim 1 wherein the initiator is selected from 2,2′-azobis (2-amidinopropane) dihydrochloride, H₂O₂/ascorbic acid, tert-butyl hydroperoxide/ascorbic acid, di-tert-butyl peroxide, tert-butyl peroxybenzoate or 2,2′-azoisobutyronitrile.

18. A composition made by the method of claim 1.

19. The composition of claim 18 wherein the polymers are cross-linked.

20. A composition comprising cross-linked, polymerized hydrocarbon particles which composition is characterized in that the particles have a weight average diameter of less than 30 nm, the particles exhibit a volume swell factor of no greater than 3.0; the composition is essentially free of metal ions; and the particles have a polydispersity. (polystyrene-relative Mw/Mn) of less than 3.0.

21. The composition of claim 20 wherein the particles are characterized by a Mark-Houwink plot having a slope with an absolute value of less than 0.4 for the peak molecular weight range.

22. The composition of claim 20 wherein the weight average diameter is less than 25 nm.

23. The composition of claim 20 wherein the weight average diameter is less than 20 nm.

24. The composition of claim 20 wherein the hydrocarbon particles are the reaction product of a styrene monomer and at least one monomer having two ethylenically unsaturated groups.

25. The composition of claim 24 wherein the monomer having two ethylenically unsaturated groups is selected from divinylbenzene and 1,3-diisopropenylbenzene.

26. The composition of claim 20 wherein the polydispersity is less than 2.5.

27. The composition of claim 20 wherein the absolute value of the slope of the Mark-Houwink plot is less than 0.3.

28. The composition of claim 20 characterized by having less than 2 ppm of any one metal ion contaminant.

29. The composition of claim 20 characterized by a total metal ion content of less than 10 ppm.

30. The composition of claim 20 characterized by a total metal ion content of less than 5 ppm.

31. The composition of claim 20 characterized by a total metal ion content of less than 2 ppm.

32. The composition of claim 20 consisting essentially of the cross-linked, polymerized hydrocarbon particles wherein the composition is further characterized in that after thermogravimetric analysis of a sample of the composition from 25 to 600° C. at 10° C./minute the decomposed residue weighs less than 10 percent of the original weight of the sample.

33. The composition of claim 32 wherein the residue weighs less than 5 percent of the original weight of the sample.

34. The composition of claim 32 wherein the residue weighs less than 2 percent of the original weight of the sample.

35. The composition of claim 20 comprising the particles dispersed in a curable matrix precursor.

36. A film comprising the composition of claim 35.

37. The composition of claim 35 further comprising a solvent.

38. A method of making a cross-linked porous film comprising making a coating composition by combining the composition of claim 37, coating the composition onto a substrate, curing the matrix precursor to form a cross-linked matrix polymer and heating to a temperature above a thermal decomposition temperature of the particles to form pores in the film.

39. The method of claim 38 wherein the substrate comprises transistors.

40. A method of making a cross-linked porous film comprising making a coating composition by combining the cross-linked polymers of the composition claim 19 with a curable precursor of a cross-linked, low dielectric constant matrix polymer and a suitable solvent system, coating the composition onto a substrate, curing the matrix polymer and heating the film to a temperature above a thermal decomposition temperature of the particles to form pores in the film.

41. The method of claim 38 wherein the matrix polymer is selected from polyarylenes, polyarylene ethers, benzocyclobutene based resins and silsesquioxane based resins.

42. The method of claim 40 wherein the matrix polymer is selected from polyarylenes, polyarylene ethers, benzocyclobutene based resins and silsesquioxane based resins.

43. The composition of claim 35 wherein the curable matrix precursor is selected from the group consisting of polyarylenes, polyarylene ethers, benzocyclobutene based resins and silsesquioxane based resins and their monomeric precursors.

44. The composition of claim 20 wherein the particles are the reaction product of a reaction mixture comprising acrylate or methacrylate functional monomers.

45. The composition of claim 35 wherein the particles are grafted to the matrix precursor.
